(19) United States
(12) Patent Application Publication
(10) Pub. No.: US 2005/0226105 A1
(43) Pub. Date: Oct. 13, 2005

(54) Method, apparatus and computer program product for implementing device selection in a robotic media library with multiple media types and multiple device types

(75) Inventors: Leon Edward Gregg, Rochester, MN (US); James Lawrence Tilbury, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/815,216

(22) Filed: Mar. 31, 2004

(51) Int. Cl. G11B 7/085

(52) U.S. Cl. 369/30.27

(57) ABSTRACT

A method, apparatus and computer program product are provided for implementing device selection in a robotic media library with multiple media types and multiple device types. A first indicator is stored with predefined media information to identify a required technology for each media. An operation request to the robotic media library is identified, checking is performed to identify multiple device types in the robotic media library. Responsive to identifying the multiple device types in the robotic media library and a default value for the first indicator, a first device type is selected. A device then is selected of the first device type.

### FIELD OF THE INVENTION

The present invention relates generally to the data processing field, and more particularly, relates to a method, apparatus and computer program product for implementing device selection in a robotic media library with multiple media types and multiple device types.

### DESCRIPTION OF THE RELATED ART

An automated storage library or robotic media library typically includes a plurality of storage bins or slots for retaining data storage media, such as magnetic tapes, magnetic disks, or optical disks, and includes a robotic picker mechanism for picking or gripping a cartridge containing the data storage medium and moving the cartridge between a storage position and an input output device or drive. In some implementations movement of the media into the disk drives for reading or writing is managed so that users are blissfully unaware that it is not physically possible to read and write all media at the same time.

As the technology evolves users want to add the latest media and disk drive technology to their expensive media libraries. Users may want to add drives of a new technology to a library which previously had drives of only one technology type. Later the user may want to replace all older drives again resulting in a library with a single technology drive. However, the management of media movement becomes much more difficult when multiple media types and multiple drive types are introduced.

In these varied environments it is necessary to be aware of the number of disk drives technologies in the library device and also be aware that some media can be used only in some disk drives while it may be possible to use some media in any of the disk drives. Finally, it is necessary to change the optical disk drive technology within a library on the fly without the need to perform manual updates or run some conversion utility.

A need exists for an effective mechanism for implementing device selection in a robotic media library with multiple media types and multiple device types.

### SUMMARY OF THE INVENTION

Principal aspects of the present invention are to provide a method, apparatus and computer program product for implementing device selection in a robotic media library with multiple media types and multiple device types. Other important aspects of the present invention are to provide such method, apparatus and computer program product for implementing device selection substantially without negative effect and that overcome many of the disadvantages of prior art arrangements.

In brief, a method, apparatus and computer program product are provided for implementing device selection in a robotic media library with multiple media types and multiple device types. A first indicator is stored with predefined media information to identify a required technology for each media. An operation request to the robotic media library is identified, and checking is performed to identify multiple device types in the robotic media library. Responsive to identifying the multiple device types in the robotic media library and a default value for the first indicator, a first device type is selected. A device then is selected of the first device type.

In accordance with features of the invention, the first device type being selected is the newest technology device type in the robotic media library. A media is placed in the selected device, then checking for successful operation is performed. Responsive to an unsuccessful operation, selecting a next device type is performed. Responsive to a successful operation, a requested operation is performed.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A and 1B are block diagram representations illustrating a computer system and operating system for implementing device selection in a robotic media library in accordance with the preferred embodiment;

FIGS. 2 and 3 are flow charts illustrating exemplary steps for implementing device selection in a robotic media library of the computer system of FIGS. 1A and 1B in accordance with the preferred embodiment;

FIG. 4 is a block diagram illustrating a computer program product in accordance with the preferred embodiment.

### DETAILED DESCRIPTION OF THE PREFERRED EMBODIMENTS

In accordance with features of the invention, a method is provided for extending the ability to manage media movement in a removable media library to a multiple device technology environment. The method of the invention allows the addition of a new technology that results in the need for media management for multiple device technology. The method of the invention effectively handles media movement when the multiple device technology exists. The method of the invention also allows a media library to revert to a homogeneous environment when the removal of one or more disk drives results in only a single technology being left in the library device. A key point is that all of this is done without the need for the user to ever specify or even be aware of media and drive compatibility issues.

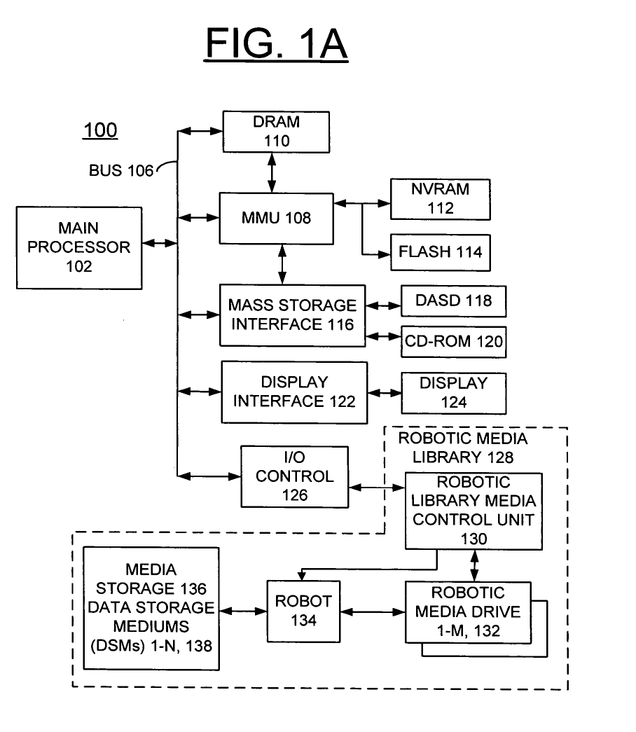

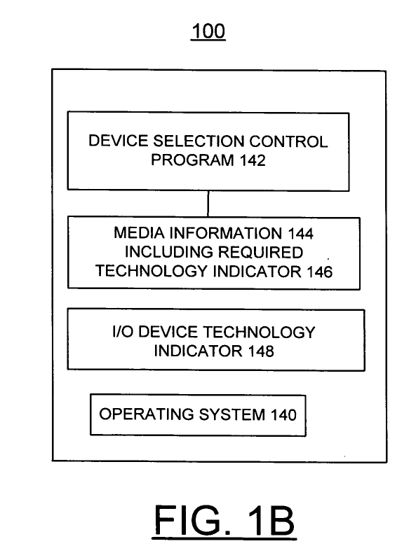

Referring now to the drawings, in FIGS. 1A and 1B there is shown a computer system generally designated by the reference character 100 for implementing device selection in a robotic media library in accordance with the preferred embodiment. Computer system 100 includes a main processor 102 or central processor unit (CPU) 102 coupled by a system bus 106 to a memory management unit (MMU) 108 and system memory including a dynamic random access memory (DRAM) 110, a nonvolatile random access memory (NVRAM) 112, and a flash memory 114. A mass storage interface 116 coupled to the system bus 106 and MMU 108 connects a direct access storage device (DASD) 118 and a CD-ROM drive 120 to the main processor 102. Computer system 100 includes a display interface 122 connected to a display 124, and an input/output (I/O) control 126 coupled to the system bus 106.

A robotic media library 128 is coupled to the I/O control 126. The robotic media library 128 includes a robotic library media control unit 130 for controlling operations in the library 128. The robotic library media control unit 130 manages the reading and writing onto a data storage medium in a selected one of a plurality of robotic media drives 1-M, 132 and manages the accessing of the data storage medium by a robot 134. The robotic library media control unit 130 manages the operation of a media storage unit 136 that is adapted to receive a plurality of removable data storage mediums (DSMs) 1-N, 138 that may include magnetic tapes, magnetic disks, and optical disks.

Computer system 100 is shown in simplified form sufficient for understanding the present invention. The illustrated computer system 100 is not intended to imply architectural or functional limitations. The present invention can be used with various hardware implementations and systems and various other internal hardware devices, for example, multiple main processors.

As shown in FIG. 1B, computer system 100 includes an operating system 140, and a device selection control program 142 of the preferred embodiment. Computer system 100 includes stored media information 144 including a required technology indicator 146 for each known media 138, and an I/O device technology indicator 148 for each device132 in accordance with the preferred embodiment. Information about each media known in the library conventionally is maintained in system storage. Stored information of the preferred embodiment includes the two new indicators 146 and 148.

In accordance with features of the invention, the method first adds the two pieces of information, the required technology indicator 146 for each media and the I/O device technology indicator 148 for each device. First, the required technology identifier 146 indicating a type of disk drive required to read and/or write the media is added to the data for each media in the stored media information 144. The value of the required technology identifier 146 is zero in a library with only one disk drive technology, or zero in a mixed drive library if a particular technology requirement has not been determined. Second, the I/O device technology indicator 148 is added to stored information for the description of each disk drive 1-M, 132 in the library 128. The system already maintains information about each of the optical disk drives 132 in the library 128 in stored information. This includes information, such as, the current status of the device, its physical address used by the robot 134, and the like. The I/O device technology indicator 148 indicates if the drive is magneto-optical (MO), write once read many (WORM), ultra-density optical (UDO), and the like. This value for the I/O device technology indicator 148 is set as each of the devices identifies itself to the host system. The I/O device technology indicator 148 can be used to determine the capabilities of a particular optical disk drive 132.

In accordance with features of the invention, when it is necessary to move a media to a disk drive the movement is done to either a drive with specified technology, or the newest technology available in the library. If a media is moved to a drive that cannot accommodate it, after initially being unsure of what technology to use, then the operation will be repeated in the next older technology. When a media is moved to a disk drive that can accommodate it, then that information, the technology indicator 148, is recorded in system storage of media information 144 including other data about the specific media. This makes the discovery process unnecessary for subsequent uses of that media.

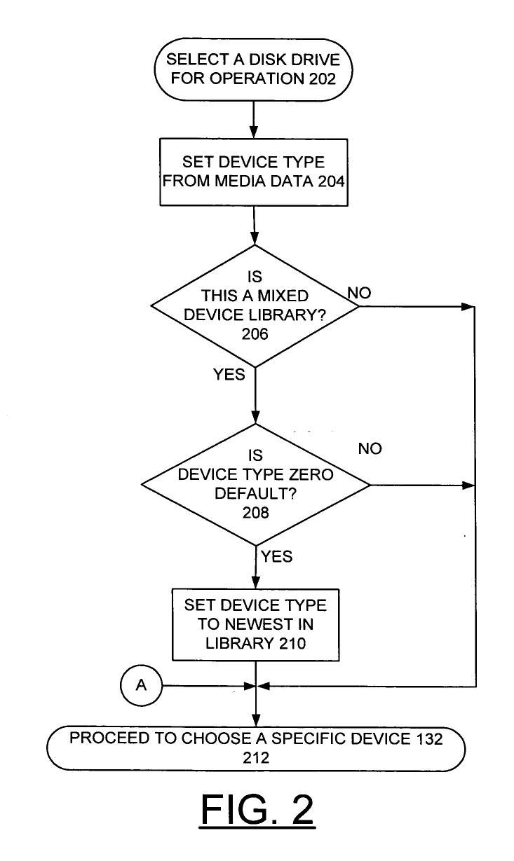

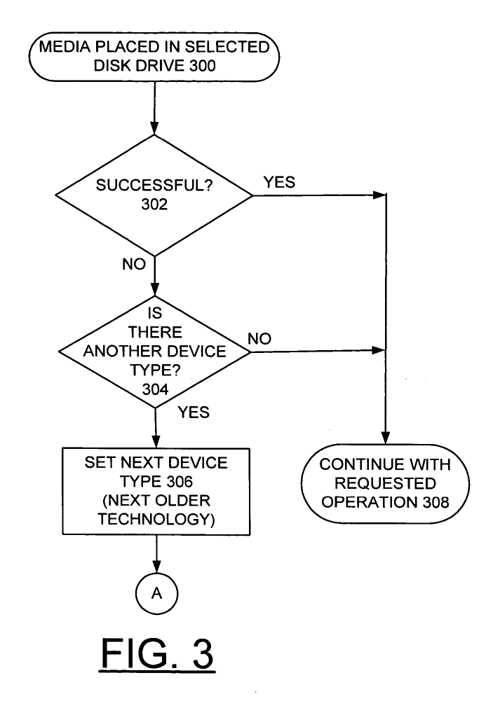

FIGS. 2 and 3 illustrate exemplary steps for implementing device selection in a robotic media library 128 in accordance with the preferred embodiment.

In accordance with features of the invention, when it is necessary to place an existing media 138 in the library 128 in one of the disk drives 132 additional checking is added to the processing before a particular drive 132 is selected. The new processing first checks if the library 128 contains multiple disk drive types. If not, we proceed directly to the selection of a particular drive as it has been done previously. This check maintains compatibility with existing function while also making it possible for a library 128 to convert from multiple drive technologies back to a single technology.

In accordance with features of the invention, if multiple drive types exist in the library 128 then first the required technology is determined from data recorded with the media in the stored media information 144. If that initial value is the default or unknown, then the newest, most capable disk drive type will be selected. Finally we proceed to the selection of a particular drive 132 of the required type. This is essentially the same device selection function currently used with the addition of the condition that selection is limited to the devices of a particular type.

Referring now to FIG. 2, the exemplary steps begin to select a disk drive for some operation as indicated in a block 202. First a device type is set using the technology indicator 148 from the stored media data 144 as indicated in a block 204. Checking is performed to determine whether this is a mixed device library as indicated in a decision block 206. If this is a mixed device library, the checking the required technology indicator 146 is performed to determine whether this is a device type zero default as indicated in a decision block 208. This value is zero in a library 128 with only one disk drive technology, and is zero in a mixed drive library if a particular technology requirement has not been determined for a media. If this is a device type zero default, then the drive type is set to the newest in the robotic media library 128 as indicated in a block 210 and the operation proceeds to choose a specific drive of the requested type as indicated in a block 212. Otherwise, when this is not a mixed device library or when this is not a device type zero default, then the operation proceeds at block 212.

In accordance with features of the invention, when the media has been placed in the chosen optical disk drive 132 checking is performed to see how well that has worked. Of course in a homogeneous device library 128 we expect this to work very well except in the rare cases of some device failure. However, in the mixed drive type library 128 it is possible for the disk drive 132 to report that it simply cannot deal with the media 138 placed in it. In this case checking is performed to see if there is another, older or less capable, drive type available. As long as another type exists, then a particular drive of that type is selected and the operation is retried. When a media 138 is successfully placed into a disk drive 132 then if the media 138 previously did not specify a particular required technology, then the required technology indicator 146 is updated for the media to indicate the type of disk drive where the media was just successfully loaded. With this required technology field 146 having been updated, subsequent uses of this media 138 will immediately be directed to a disk drive 132 of the proper type avoiding the trial and error process.

Referring now to FIG. 3, the exemplary steps begin after the media 138 has been placed in a selected disk drive 132 as indicated in a block 300. Checking is performed to determine if the operation was successful as indicated in a decision block 302. If the operation was not successful, checking is performed to determine if there is another device type in the library 128 as indicated in a decision block 304. If there is another device type in the library 128, then a next device type is set as indicated in a block 306, for example, to set the next device type to a next older technology. Then the exemplary steps continue to retry the operation following entry point A at block 212 in FIG. 2. Otherwise when the operation was successful or if determined that there is no other device type in the library 128, then the exemplary steps continue with the requested operation as indicated in a block 308.

In brief summary of features of the invention, first the processing of media in the library with only a single disk drive technology is allowed exactly the way it has been done conventionally. Secondly, the method of the invention makes it possible to introduce another disk drive technology on the fly without any need for a conversion process when the additional drive types are added. Third, the method of the invention allows a previously existing media to correctly identify its required technology after a first use so that in the future the media will always be loaded in the correct disk drive type without requiring multiple trial and error operations. Finally the method of the invention continues to work, for example, when older type drives are eventually removed which returns the library 128 to a homogeneous disk drive environment.

It should be understood that processing for new media 138 being added to the library 128 is modified in a similar manner. When a media 138 is added to the library 128 the first check is to determine if the library 128 includes multiple disk drive types. If not, we proceed directly to the selection of a particular disk drivel 32 for the operation. If multiple drive types are present we initially make a default assignment of the newest technology device. A disk drive 132 of this type is selected for the operation. If the operation succeeds the required technology data 146 for the media 138 is updated and nothing further is required. If the operation fails because the disk drive 132 could not handle the media type, then we select the next oldest disk drive technology present and retry the operation. This proceeds until the media 138 is successfully handled. It is possible that no disk drive 132 can deal with the media. However, this is not a new situation because there have always been media 138 which the disk drives 132 in a library 128 cannot handle. If the media 138 cannot be handled successfully and no more disk drive types exist, then the media is rejected as incompatible. This is the same as would happen in a library 128 with only one optical disk drive type when there is an attempt to add a media which the disk drives 132 cannot handle.

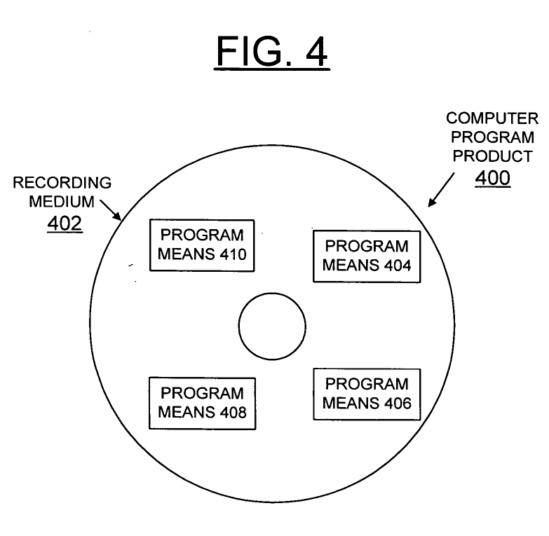

Referring now to FIG. 4, an article of manufacture or a computer program product 400 of the invention is illustrated. The computer program product 400 includes a recording medium 402, such as, a floppy disk, a high capacity read only memory in the form of an optically read compact disk or CD-ROM, a tape, a transmission type media such as a digital or analog communications link, or a similar computer program product. Recording medium 402 stores program means 404, 406, 408, 410 on the medium 402 for carrying out the methods for implementing device selection of the preferred embodiment in the system 100 of FIGS. 1A and 1B.

A sequence of program instructions or a logical assembly of one or more interrelated modules defined by the recorded program means 404, 406, 408,410, direct the computer system 100 for implementing device selection in a robotic media library 128 with multiple media types and multiple device types of the preferred embodiment.

While the present invention has been described with reference to the details of the embodiments of the invention shown in the drawing, these details are not intended to limit the scope of the invention as claimed in the appended claims.

1. A method for implementing device selection in a robotic media library with multiple media types and multiple device types comprising the steps of:
storing a first indicator with predefined media information to identify a required technology for each media;
identifying an operation request to the robotic media library;
responsive to said operation request, checking for multiple device types in the robotic media library;
responsive to identifying the multiple device types in the robotic media library and a default value for said first indicator, selecting a first device type; and
selecting a device of said selected first device type.

2. A method for implementing device selection in a robotic media library as recited in claim 1 includes the steps responsive to said operation request, of setting a device type from said predefined media information.

3. A method for implementing device selection in a robotic media library as recited in claim 1 wherein the step, responsive to identifying the multiple device types in the robotic media library and a default value for said first indicator, of selecting said first device type includes the steps of storing a value representing said first device type for said first indicator.

4. A method for implementing device selection in a robotic media library as recited in claim 1 wherein the step, responsive to identifying the multiple device types in the robotic media library and a default value for said first indicator, of selecting said first device type includes the steps of selecting a newest device type in the robotic media library for said first device type.

5. A method for implementing device selection in a robotic media library as recited in claim 1 includes the steps responsive to selecting said device of said selected first device type, placing media in said selected device.

6. A method for implementing device selection in a robotic media library as recited in claim 5 further includes the steps of checking for successful operation, and responsive to an unsuccessful operation, selecting a next device type.

7. A method for implementing device selection in a robotic media library as recited in claim 6 wherein the step of selecting said next device type includes the steps of selecting a next oldest device type in the robotic media library for said next device type.

8. A method for implementing device selection in a robotic media library as recited in claim 6 includes the steps of selecting a second device of said selected next device type, placing media in said selected second device.

9. A method for implementing device selection in a robotic media library as recited in claim 8 further includes the steps of checking for successful operation, and responsive to an unsuccessful operation, selecting a next device type.

10. A method for implementing device selection in a robotic media library as recited in claim 8 further includes the steps of checking for successful operation, and responsive to said successful operation, continuing with a requested operation.

11. A method for implementing device selection in a robotic media library as recited in claim 1 includes the steps of storing a second indicator to describe each said device in said robotic media library.

12. A method for implementing device selection in a robotic media library as recited in claim 11 includes the steps of storing said second indicator with predefined information for each said device in said robotic media library.

13. A computer program product for implementing device selection in a robotic media library in a computer system, said computer program product including instructions executed by the computer system to cause the computer system to perform the steps of:
storing a first indicator with predefined media information to identify a required technology for each media;
identifying an operation request to the robotic media library;
responsive to said operation request, checking for multiple device types in the robotic media library;
responsive to identifying the multiple device types in the robotic media library and a default value for said first indicator, selecting a first device type; and
selecting a device of said selected first device type.

14. A computer program product for implementing device selection as recited in claim 13 includes the steps responsive to said operation request, of setting a device type from said predefined media information.

15. A computer program product for implementing device selection as recited in claim 13 wherein the step of selecting said first device type includes the steps of storing a value representing said first device type for said first indicator.

16. A computer program product for implementing device selection as recited in claim 13 wherein the step of selecting said first device type includes the steps of selecting a newest device type in the robotic media library for said first device type.

17. A computer program product for implementing device selection as recited in claim 13 includes the steps responsive to selecting said device of said selected first device type, placing media in said selected device.

18. A computer program product for implementing device selection as recited in claim 17 further includes the steps of checking for successful operation, and responsive to an unsuccessful operation, selecting a next device type.

19. Apparatus for implementing device selection in a robotic media library comprising:
a stored media information;
a first indicator stored with predefined media information to identify a required technology for each media;
a device selection control program for identifying an operation request to the robotic media library; responsive to said operation request, for checking for multiple device types in the robotic media library; responsive to identifying the multiple device types in the robotic media library and a default value for said first indicator, for selecting a first device type; and for selecting a device of said selected first device type.

20. Apparatus for implementing device selection in a robotic media library as recited in claim 19 wherein said device selection control program responsive to media being placed in said selected device, performs checking for successful operation, and responsive to an unsuccessful operation, selects a next device type.

21. Apparatus for implementing device selection in a robotic media library as recited in claim 19 wherein said device selection control program responsive to media being placed in said selected device, performs checking for successful operation, and responsive to said successful operation, continues with a requested operation.

22. Apparatus for implementing device selection in a robotic media library as recited in claim 19 wherein said device selection control program stores a second indicator to describe each said device in said robotic media library.
